(19) United States
(12) Patent Application Publication
(10) Pub. No.: US 2007/0189130 A1
(43) Pub. Date: Aug. 16, 2007

(54) Optical information device and information recording and reproduction device

(76) Inventors: Joji Anzai, Osaka (JP); Shin-ichi Kadowaki, Hyogo (JP); Fumitomo Yamasaki, Nara (JP); Eishin Mori, Kyoto (JP)

Correspondence Address: WENDEROTH, LIND & PONACK L.L.P., 2033 K. STREET, NW, SUITE 800, WASHINGTON, DC, 20006, US

(21) Appl. No.: 10/592,641

(22) PCT Filed: Aug. 24, 2005
(86) PCT No.: PCT/JP05/15368

§ 371 Date: Sep. 13, 2006

(30) Foreign Application Priority Data
Sep. 9, 2004 (JP) 2004-261919

(51) Int. Cl. G11B 7/00

(52) U.S. Cl. 369/44.23; 369/44.41

(57) ABSTRACT

Stable tracking control is achieved for an optical recording medium having a plurality of information recording planes. To achieve this, an optical information device comprises a light source for emitting a light beam, a focusing unit for converging the light beam emitted from the light source onto a predetermined information recording plane of an optical recording medium having a plurality of information recording planes, a beam splitting unit for splitting the light beam reflected by the optical recording medium, and a light detection unit having a light receiver that receives the light beam split by the beam splitting unit, for outputting a signal corresponding to the light intensity of the light beams received by the light receiver. A guide groove is formed on at least one of the information recording planes, and the light receiver is entirely disposed within in a map formed on the light detection unit by the light beam reflected by an information recording plane other than the predetermined information recording plane.

### TECHNICAL FIELD

The present invention relates to an optical information device and an information recording and reproduction device, and more particularly relates to an optical information device for recording, reproducing, or erasing information to or from an optical recording medium, and to an information recording and reproduction device that uses the optical information device for recording, reproducing, or erasing information to or from an optical recording medium.

### BACKGROUND ART

Recent years have witnessed the practical application of a type of optical disk of high density and capacity, called a DVD, and this type of disk has gained widespread acceptance as an information medium capable of handling large amounts of information, such as video images.

FIG. 13 shows the structure of a conventional optical pickup used in recording and reproduction with an optical recording medium such as this. Here, by irradiating the optical recording medium with three light beams, a tracking error signal is detected (see Patent Document 1, for example).

A light source 1 comprising of a semiconductor laser or the like emits a divergent beam 70 of linearly polarized light with a wavelength λ1 of 405 nm. The divergent beam 70 emitted from the light source 1 is converted into parallel light by a collimating lens 53 with a focal distance fl of 15 mm, after which the beam is incident on a polarized beam splitter 52. The incident beam 70 passes through the polarized beam splitter 52, then passes through a quarter-wave plate 54, and is thereby converted into circularly polarized light, after which it is converted into a focused beam by an objective lens 56 with a focal distance f2 of 2 mm, then passes through a transparent substrate 41 of an optical recording medium 40, and is converged on an information recording plane 40b. The opening of the objective lens 56 is limited by an aperture 55, with the numerical aperture NA set to 0.85. The thickness of the transparent substrate 41 is 0.1 mm. The optical recording medium 40 has an information recording plane 40b. A continuous groove that serves as a track is formed in the optical recording medium 40, and the track pitch tp is 0.32 μm.

The beam 70 reflected by the information recording plane 40b passes through the objective lens 56 and the quarter-wave plate 54 and is thereby converted into linearly polarized light that its direction is different by 90 degrees with respect to the outward path, after which the beam is reflected by the polarized beam splitter 52. The beam 70 reflected by the polarized beam splitter 52 passes through a converging lens 59 with a focal distance f3 of 30 mm and is thereby converted into focused light, then is incident on a photodetector 30 via a cylindrical lens 57. Astigmatism is imparted to the beam 70 as it passes through the cylindrical lens 57.

The photodetector 30 has four light receivers 30a to 30d. The light receivers 30a to 30d output current signals I30a to I30d corresponding to the light intensity received by each.

A focus error (hereinafter referred to as FE) signal produced by an astigmatism method is obtained by (I30a+I30c)−(I30b+I30d). A tracking error (hereinafter referred to as TE) signal produced by push-pull method is obtained by (I30a +I30d)−(I30b+I30c). An information signal recorded to the optical recording medium 40 (hereinafter referred to as RF) is obtained by I30a+I30b+I30c+I30d. The FE signal and TE signal are amplified to the desired level and subjected to phase compensation, after which they are supplied to actuators 91 and 92 and subjected to focus and tracking control.

In general, to increase the volume of information that can be stored in a single optical recording medium 40, as the track pitch is narrowed, the accuracy of track production has to be increased by a corresponding amount. Actually, however, since a certain absolute amount of error is present, as the track pitch is narrowed, there is a relative increased in the amount of production error with respect to track pitch. Therefore, the effect of this error is far greater than with a DVD.

FIG. 14 is a graph of the TE signal obtained when the beam 70 was scanned at a right angle to the tracks formed in the optical recording medium 40. Tn−4, . . . , Tn+4 shown on the horizontal axis indicate the tracks formed in the information recording plane 40b of the optical recording medium 40. The solid lines extending vertically in the graph indicate the central locations of the tracks Tn−4, . . . , Tn+4 when the track pitch is formed consistently as tp. Here, tracks Tn−1 and Tn are formed at locations that are offset from the locations where tracks Tn−1 and Tn are supposed to have been formed, by Δn−1 and Δn, respectively. Δn −1 is +25 nm, and Δn is −25 nm. As a result, the amplitude of the TE signal fluctuates greatly. Here, we will let S1 be the minimum amplitude in the vicinity of track Tn −1, and S2 the maximum amplitude. The location of the zero cross point of the TE signal is offset from the centers of tracks Tn −1 and Tn. Here, we will let oft1 by the offset of track Tn −1, and oft2 that of track Tn. Specifically, the offset oft1 and the offset oft2 express the off-track amount.

The amount of fluctuation in the TE signal amplitude is defined as ΔPP=(amplitude S2−amplitude S1)/(amplitude S2+amplitude S1), and when a TE signal is detected with a conventional configuration such as that described above, the amount of fluctuation ΔPP is 0.69, the offset oft1 is +33 nm, and the offset oft2 is −33 nm, which are large values. When the TE signal amplitude thus fluctuates so greatly (at a large fluctuation ΔPP), there is a decrease in the gain of tracking control in tracks Tn −1 and Tn, tracking control becomes unstable, and information can no longer be recorded and reproduced at high reliability.

Patent Document 1: Japanese published unexamined patent application H3-005927

### DISCLOSURE OF THE INVENTION

It is an object of the present invention to provide an optical pickup head device, optical information device, and information reproduction method with which fluctuation in the TE signal amplitude is reduced and information can be recorded or reproduced at high reliability.

To solve the above problems, the optical information device pertaining to the present invention comprises a light source for emitting a light beam, a focusing unit for converging the light beam emitted from the light source onto a predetermined information recording plane of an optical recording medium having a plurality of information recording planes, a beam splitting unit for splitting the light beam reflected by the optical recording medium, and a light detection unit having a light receiver that receives the light beam split by the beam splitting unit, for outputting a signal corresponding to the light intensity of the light beams received by the light receiver, wherein a guide groove is formed on at least one of the information recording planes, and the light receiver is entirely disposed within a map formed on the light detection unit by the light beam reflected by an information recording plane other than the predetermined information recording plane (hereinafter referred to as non-convergence plane).

This reduces fluctuation in the tracking error signal amplitude and allows information to be recording or reproduced at high reliability.

The optical information device pertaining to the present invention further comprises an astigmatism generation unit disposed along the optical path between the focusing unit and the light receiver.

The astigmatism generation unit is preferably a cylindrical lens.

Further, the light detection unit has a plurality of the light receivers, and each of the light receivers is disposed so as to receive the light beam reflected by the same non-convergence plane.

At least a portion of the plurality of light receivers are disposed roughly adjacent to each other, and the light beams split by the beam splitting unit are each received by said portion of the light receivers.

The beam splitting unit has at least first to fourth regions, and the light beam split in the first to forth regions is incident on the light receiver that outputs a signal for producing a tracking error signal.

The light beams split in the first and second regions mainly include 1^{st} order diffracted light diffracted by the track of the optical recording medium, the light beams split in the third and fourth regions mainly include zero-order diffracted light diffracted by the track of the optical recording medium, the light detection unit has first to fourth light receivers that receive the light beams split in the first to fourth regions, respectively, and the tracking error signal is expressed by (I1−I2)−K·(I4−I3), where I1 to I4 are signals outputted from the first to fourth light receivers, and K is a real number.

The optical information device pertaining to the present invention is such that the beam splitting unit has at least first to fourth regions, the light beams split in the first and second regions mainly include 1^{st} order diffracted light diffracted by the track of the optical recording medium, the light beams split in the third and fourth regions mainly include zero-order diffracted light diffracted by the track of the optical recording medium, the light detection unit has first to fourth light receivers that receive the light beams split in the first to fourth regions, respectively, and a fifth light receiver disposed at a location where the light beams split by the beam splitting unit are not received, and the tracking error signal is expressed by ((I1−I2)−K·(I4−I3))−L·15, where I1 to I5 are signals outputted from the first to fifth light receivers, and K and L are real numbers.

This reduces fluctuation in the tracking error signal amplitude and allows information to be recording or reproduced at high reliability.

Also, the beam splitting unit is a diffraction grating, and a tracking error signal is produced by using the +1^{st} order diffracted light or −1^{st} order diffracted light diffracted by the diffraction grating.

The light receivers for receiving the +1^{st} order diffracted light and −1 order diffracted light diffracted by the diffraction grating are disposed substantially in axially symmetric locations on either side of the optical axis of the zero-order diffracted light of the diffraction grating, and a tracking error signal is produced using both +1^{st} order diffracted light and −1^{st} order diffracted light.

The optical information device also comprises a light source for emitting a light beam, a focusing unit for converging the light beam emitted from the light source onto a predetermined information recording plane of an optical recording medium having a plurality of information recording planes, a beam splitting unit for splitting the light beam reflected by the optical recording medium, an opening limiting unit disposed in the vicinity of the beam splitting unit, and a light detection unit having a light receiver that receives the light beam split by the beam splitting unit, for outputting a signal corresponding to the light intensity of the light beams received by the light receiver, wherein a guide groove is formed on at least one of the information recording planes, the light detection unit has at least a first light receiver for focus control and a second light receiver for tracking control, and the second light receiver is disposed outside a map formed on the light detection unit by the light beam reflected by an information recording plane other than the predetermined information recording plane (hereinafter referred to as non-convergence plane) and limited by the opening limiting unit.

This reduces fluctuation in the tracking error signal amplitude and allows information to be recording or reproduced at high reliability.

The optical information device further comprises an astigmatism generation unit disposed along the optical path between the focusing unit and the light receivers.

The astigmatism generation unit is preferably a cylindrical lens.

The second light receiver is disposed, with respect to the first light receiver, in a disposition direction other than the direction in which the light beam is diffracted by the track of the optical recording medium.

The disposition direction is a direction rotated by approximately 40 to 50 degrees from the direction in which the light beam is diffracted by the track of the optical recording medium.

The second light receiver has a plurality of light receiving regions disposed roughly adjacent to each other, and the light beams split by the beam splitting unit are received in these light receiving regions.

Also, the beam splitting unit has at least four regions, and the light beams split in the regions are incident on the second light receiver that outputs a signal for producing a tracking error signal.

Also, the beam splitting unit is preferably a diffraction grating.

Also, the opening limiting unit is preferably formed integrally with the beam splitting unit.

The information recording and reproduction device pertaining to the present invention comprises any of the above optical information devices, a transfer controller for moving the optical information device, a controller for controlling the optical information device and the transfer controller, a recording and reproduction unit for recording and/or reproducing information to or from an optical recording medium using the optical information device, and a rotating unit for rotationally moving the optical information device.

The present invention provides an optical information device with which fluctuation in the tracking error signal amplitude is reduced and information can be recorded or reproduced at high reliability.

### BRIEF DESCRIPTION OF THE DRAWINGS

FIG. 1 is a diagram of the structure of an optical information device in Embodiment 1 of the present invention;

FIG. 2 is a diagram of the simplified structure of an optical pickup in the optical information device of Embodiment 1 of the present invention;

FIG. 3 is a diagram of the structure of a beam splitting element that forms part of the optical information device of Embodiment 1 of the present invention;

FIG. 4 is a diagram of the structure of a photodetector that forms part of the optical information device of Embodiment 1 of the present invention;

FIG. 5 is a diagram of the structure of a photodetector that forms part of the optical information device of Embodiment 1 of the present invention;

FIG. 6 is a diagram of the structure of a photodetector that forms part of the optical information device of Embodiment 1 of the present invention;

FIG. 7 is a diagram of the structure of a photodetector that forms part of the optical information device of Embodiment 1 of the present invention;

FIG. 8 is a diagram of the structure of a photodetector that forms part of the optical information device of Embodiment 2 of the present invention;

FIG. 9 is a diagram of the structure of a photodetector that forms part of the optical information device of Embodiment 3 of the present invention;

FIG. 10 is a diagram of the simplified structure of an optical information device of Embodiment 4 of the present invention;

FIG. 11 is a diagram of the structure of the opening limiting unit that forms part of the optical information device of Embodiment 4 of the present invention;

FIG. 12 is a diagram of the structure of a photodetector that forms part of the optical information device of Embodiment 4 of the present invention;

FIG. 13 is a diagram of the structure of an optical pickup head device that forms part of a conventional optical information device; and

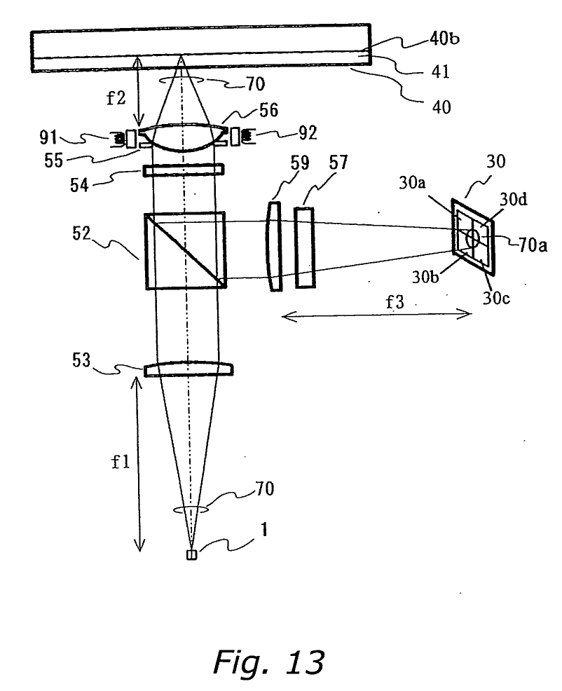

FIG. 14 is a diagram of the TE signal obtained with a conventional optical information device.

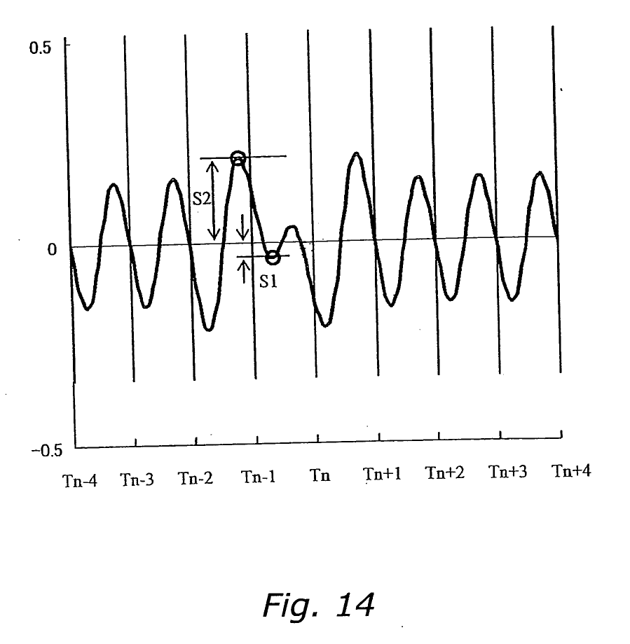

### NUMERICAL REFERENCES

32 to 35 photodetectors

32a to 32h, 33a to 33i, 35a to 35h light receivers

40 optical recording medium

52 polarized beam splitter

53 collimating lens

54 wave plate

56 objective lens

57 cylindrical lens

59 converging lens

60 to 62 beam splitting elements (diffraction gratings)

70 to 73, 71a to 71h beams

91, 92 actuator

93 spherical aberration correction unit

201, 202 optical pickup head device

### DETAILED DESCRIPTION OF THE PREFERRED EMBODIMENT

The optical information device pertaining to the present invention and embodiments of an optical pickup device and an optical information reproduction method will now be described through reference to the drawings. Components that are numbered the same in the drawings have either the same structure element or the same action and operation.

### Embodiment 1

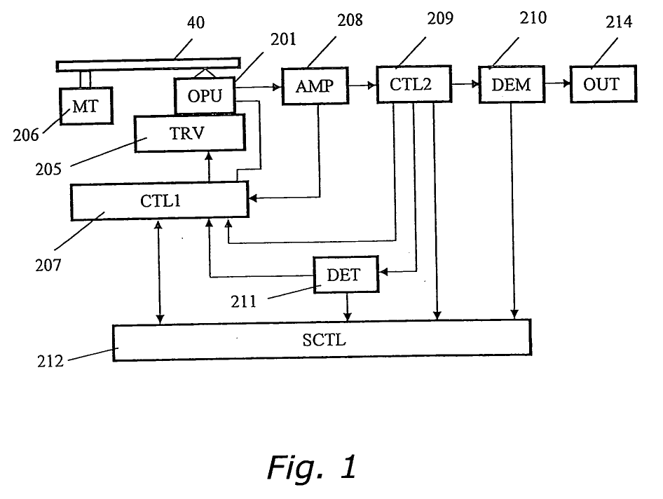

FIG.1 is a diagram of the structure of an optical information device in Embodiment 1 of the present invention.

An optical pickup head device 201 (also called an optical pickup) irradiates an optical recording medium 40 with a laser beam having a wavelength μ of 405 nm, and a signal recorded to the optical recording medium 40 is reproduced. A transfer controller 205 moves the optical pickup device 201 in the radial direction of the optical recording medium 40 in order to record or reproduce information at the desired location on the optical recording medium 40. A motor 206 that drives the optical recording medium 40 rotates the optical recording medium 40. A controller 207 controls the optical pickup head device 201, the transfer controller 205, and the motor 206.

An amplifier 208 amplifies a signal read by the optical pickup head device 201. An output signal from the amplifier 208 is inputted to a controller 209. On the basis of this signal, the controller 209 produces a servo signal such as an FE signal, TE signal, and so forth that is required by the optical pickup device 201 in the reading of the signal of the optical recording medium 40, and the resulting signal is outputted to the controller 207. The signal inputted to the controller 209 is an analog signal, but this analog signal is digitized (binarized) by the controller 209. A demodulator 210 analyzes the signal that has been read from the optical recording medium 40 and digitized, and reconstructs the original data (such as a video image or music), and the reconstructed signal is outputted from an output device 214.

A detector 211 detects an address signal and so forth on the basis of the signal outputted from the controller 209, and this signal is outputted to a system controller 212. The system controller 212 identifies the optical recording medium 40, decodes recording and reproduction conditions and so forth, and controls the overall optical information device on the basis of optical recording medium manufacture information (optical recording medium management information) and physical format information read from the optical recording medium 40. When information is to be recorded to or reproduced from the optical recording medium 40, the controller 207 controls the drive of the transfer controller 205 according to a command from the system controller 212. As a result, as shown in FIG. 1, the transfer controller 205 moves the optical pickup head device 201 to the desired location on the information recording plane formed on the optical recording medium 40 (discussed below), and the optical pickup head device 201 records or reproduces information to or from the information recording plane of the optical recording medium 40.

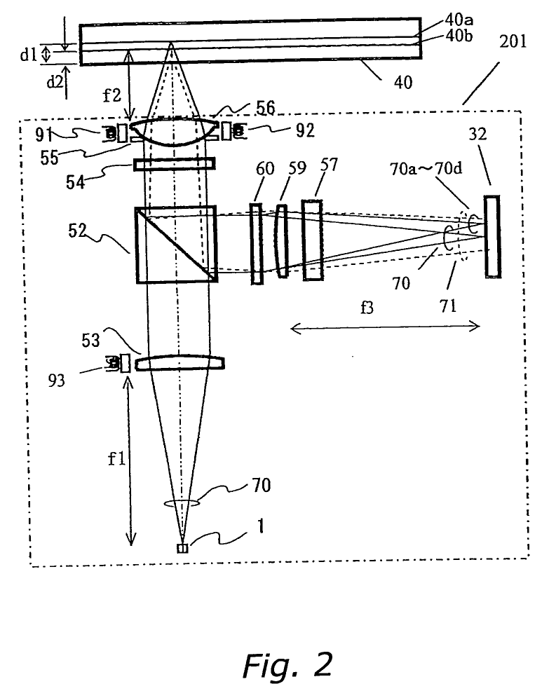

FIG. 2 is a diagram of an example of the structure of the optical pickup head device 201 pertaining to the present invention.

A light source 1 emits a divergent beam 70 of linearly polarized light with a wavelength μ of 405 nm. The divergent beam 70 emitted from the light source 1 is converted into parallel light by a collimating lens 53 with a focal distance fl of 18 mm, after which the beam passes through a polarized beam splitter 52, then passes through a quarter-wave plate 54, and is thereby converted into circularly polarized light. After this, it is converted into a focused beam by an objective lens 56 with a focal distance f2 of 2 mm, then passes through a transparent substrate formed on the optical recording medium 40, and is converged on an information recording plane 40a. The opening of the objective lens 56 is limited by an aperture 55, with the numerical aperture NA set to 0.85. Information recording planes 40a and 40b are formed in the optical recording medium 40, the thickness d1 of the optical recording medium 40 from its surface to the information recording plane 40a is 0.1 mm, the thickness d2 to the information recording plane 40b is 75 μm, and the refractive index n is 1.57. A stepper motor or the like is used to allow the collimating lens 53 to move in the direction of the optical axis, as a spherical aberration correction unit 93 for correcting spherical aberration generated by a difference between the substrate thicknesses d1 and d2 of the information recording planes 40a and 40b.

The beam 70 reflected by the information recording plane 40a passes through the objective lens 56 and the quarter-wave plate 54 and is thereby converted into linearly polarized light that its direction is different by 90 degrees with respect to the outward path, after which the beam is reflected by the polarized beam splitter 52. The beam 70 reflected by the polarized beam splitter 52 is split by a diffraction grating 60 (a beam splitting element) into zero-order diffracted light and 1^{st}-order diffracted light, through a converging lens 59 with a focal distance f3 of 30 mm and a cylindrical lens 57, and is incident on a photodetector 32. The beam 70 that is incident on the photodetector 32 is imparted with astigmatism while passing through the cylindrical lens 57.

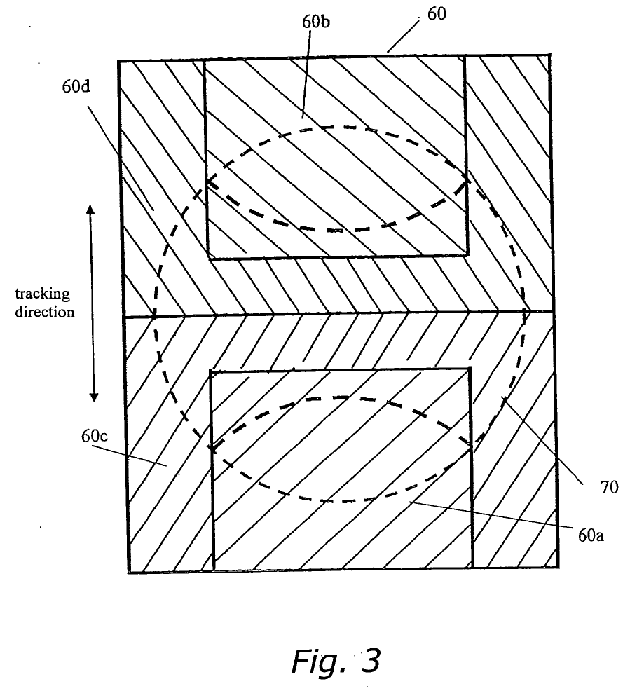

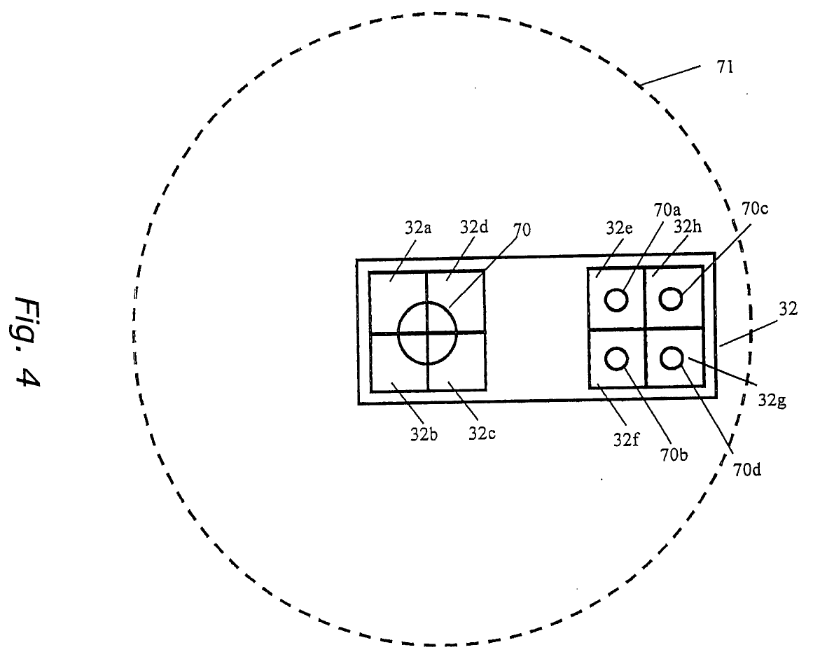

FIG. 3 schematically shows the structure of the diffraction grating 60, and FIG. 4 the relationship between the photodetector 32, the beam 70 received by the photodetector 32, and the beams 70a to 70d.

The diffraction grating 60 may have a lateral cross sectional shape that is either a simple grooved shape, or a stepped or serrated blazed shape, and has a total of four different regions 60a to 60d. The 1^{st}-order diffracted light diffracted in the region 60a is expressed as 70a, the 1^{st}-order diffracted light diffracted in the region 60b is expressed as 70b, the 1^{st}-order diffracted light diffracted in the region 60b is expressed as 70b, the 1^{st}-order diffracted light diffracted in the region 60c is expressed as 70c, and the 1^{st} -order diffracted light diffracted in the region 60d is expressed as 70d. The various regions are split up and constituted such that regions 60a and 60b include most of the tracking groove component, which is 1^{st}-order diffracted light diffracted by the track of the information recording plane 40a, while regions 60c and 60dinclude substantially none of this tracking groove component. The diffraction grating 60 is designed so that the diameter of the beam 70 that is incident on the diffraction grating 60 after being reflected by the polarized beam splitter 52 is usually about 2 to 4 mm.

An FE signal is obtained by astigmatism method using the signals I32a to 132d outputted from the photodetector 32, that is, by (I32a +I32c) - (I32b +I32d). A TE signal is obtained by (I32e - I32f) −K·(I32h - I32g), where K is a real number.

After the FE signal and TE signal have been amplified and phase-corrected to the desired levels, they are supplied to the actuators 91 and 92 for moving the objective lens 56, and then subjected to focus and tracking control.

If the beam 70 has been focused on the information recording plane 40a, it is greatly defocused on the information recording plane 40b. Accordingly, of the beam 71 reflected by the information recording plane 40b, the zero-order diffracted light that has passed through the diffraction grating 60 is greatly defocused on the photodetector 32. Here, light receivers 32e to 32j are disposed so that the beam 71 will always be incident on the light receivers 32e to 32h. The purpose of this is to prevent disturbance from occurring in the TE signal due to whether or not the beam 71 is incident on the light receivers 32e to 32hwhen the thickness varies between layers (between the information recording planes 40a and 40b), which would result in an inability to control tracking stably. Thus, even when the thickness varies between layers (between the information recording planes 40a and 40b), the beam 71 will always be incident on the light receivers 32e to 32h, and this design yields a TE signal with less disturbance and allows tracking error to be controlled more stably. Therefore, with the optical information device in this embodiment, fluctuation in the TE signal amplitude is reduced and tracking can be carried out more stably, so information can be recorded or reproduced at high reliability.

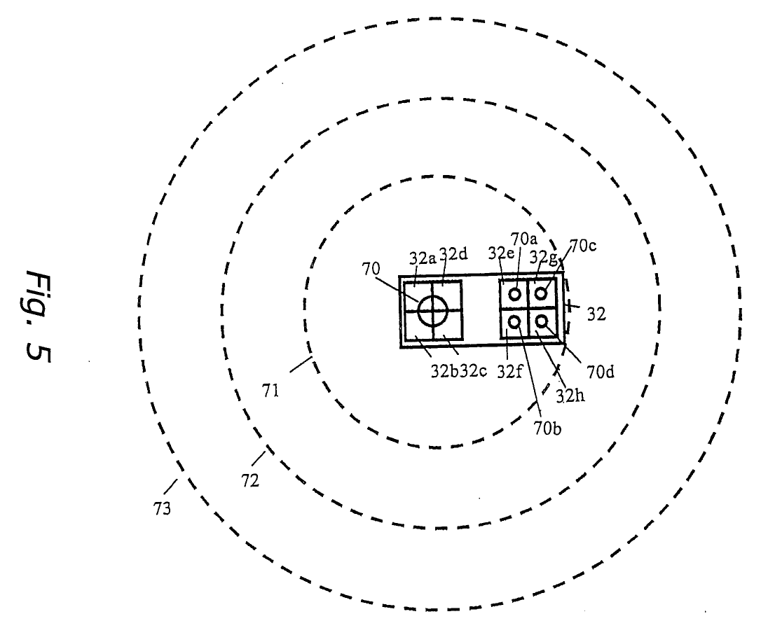

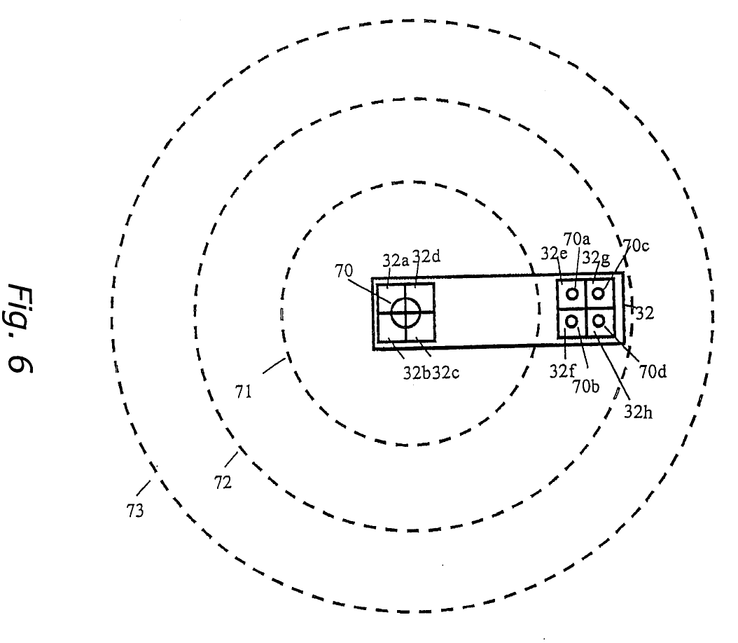

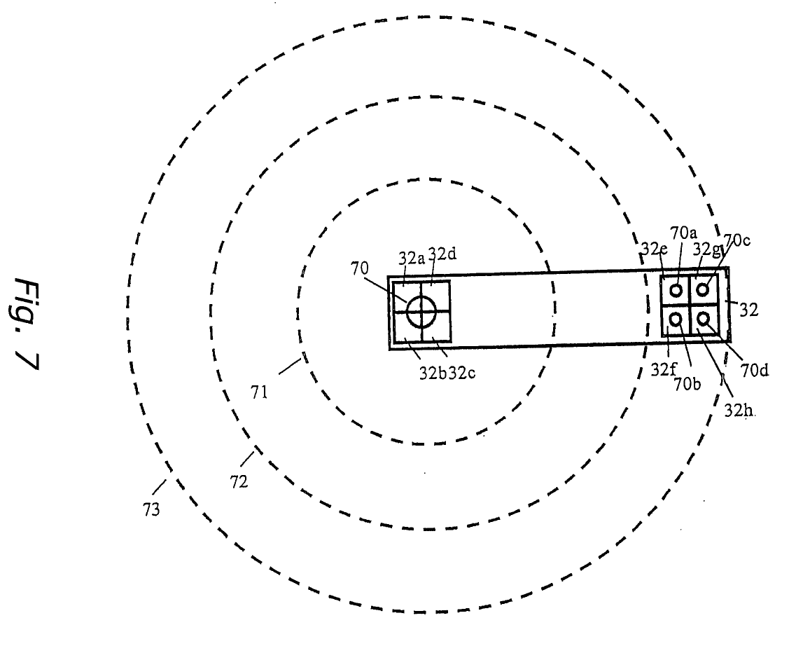

Also, an optical recording medium comprising two layers of information recording plane was described in this embodiment, but the same effect will be obtained with an optical recording medium having more information recording planes. FIGS. 5 to 7 show the relationship between the photodetector 32 and the beam reflected from an optical recording medium having four layers of information recording plane. Information recording planes are expressed as 40a, 40b, 40c, and 40d, and the beams reflected from these respective information recording planes are expressed as 70, 71, 72, and 73. As shown in FIG. 5, when the focus is on the information recording plane 40a, for example, the beams on the photodetector 32 are disposed so that the beam 71 will be incident on the light receivers 32e to 32h, and the diffraction angle is set so that the beams 70a to 70d split by the regions 60a to 60d of the diffraction grating 60 will be incident on the light receivers 32e to 32h, the result of which is that tracking error can be controlled more stably. Also, as shown in FIG. 6, the light receivers 32e to 32h may be disposed at positions where the beam 71 is not incident, and the beam 72 is always incident. Also, as shown in FIG. 7, these may be disposed at positions where the beams 71 and 72 are not incident, and the beam 73 is always incident, and here again the same effect will be obtained.

### Embodiment 2

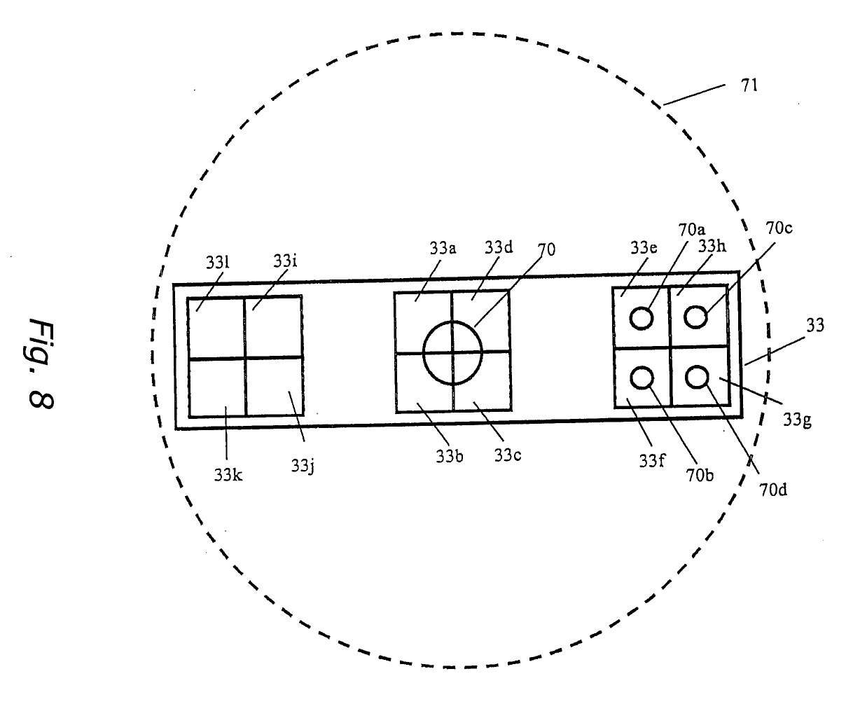

FIG. 8 is a schematic diagram of the relationship between a photodetector 33 used in this embodiment and the beams 70, 71, and 70a to 70d received by the photodetector 33.

The difference between the optical pickup in this embodiment and the optical pickup in Embodiment 1 is that the photodetector 33 is used instead of the photodetector 32. The difference between the photodetector 32 and the photodetector 33 is that light receivers 33i to 331 are disposed at positions in substantially axial symmetry with light receivers 33e to 33h with respect to the center of the beam 71 reflected by the information recording plane 40b, where the beam is not focused. The TE signal when this photodetector 33 is used is obtained by (I33e−I33j)−(I33f−I33i)−K·((I33h−I33k)−(I33g−I33l)), where K is a real number.

In this case, stray light from the beam 71 reflected by the information recording plane 40b where the light receivers 33e to 33h for producing the TE signal are incident is canceled out by the light receiver 33i on which the beam 71 is similarly incident, which yields a TE signal with less disturbance and allows tracking error to be controlled more stably. Therefore, with the optical information device of this embodiment, fluctuation in the TE signal amplitude is reduced and tracking can be carried out more stably, so information can be recorded or reproduced at high reliability.

### Embodiment 3

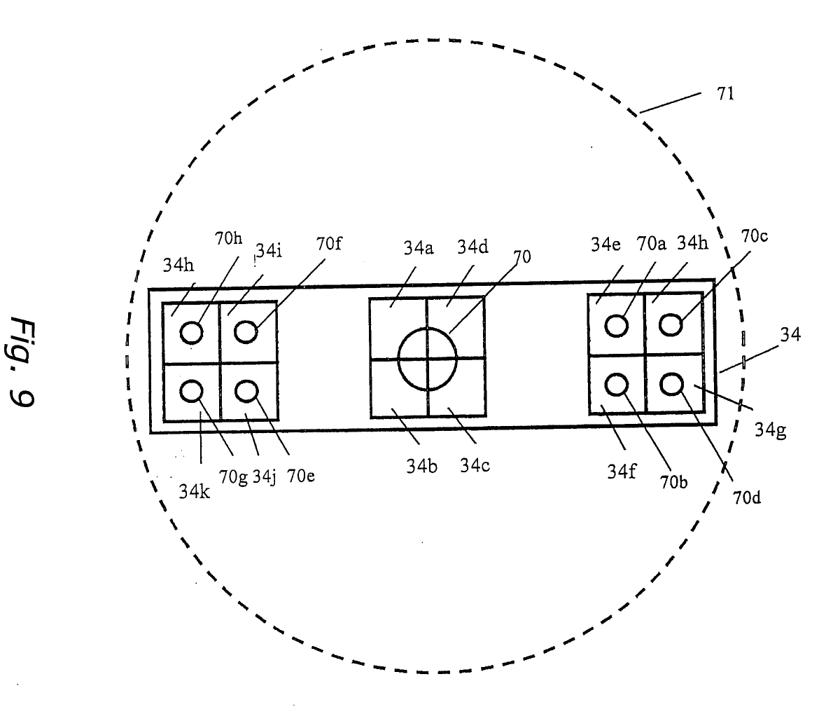

FIG. 9 is a schematic diagram of the relationship between a photodetector 34 used in this embodiment and the beams 70 and 70a to 70n received by the photodetector 34.

The difference between the optical pickup in this embodiment and the optical pickup in Embodiment 1 is that a diffraction grating 61 (not shown) is used instead of the diffraction grating 60, and the photodetector 34 is used instead of the photodetector 32. The diffraction grating 60 in Embodiment 1 could have a lateral cross sectional shape that was either a simple grooved shape, or a stepped or serrated blazed shape, but the diffraction grating 61 in this embodiment has a simple groove-shaped cross section that generates ± diffracted light. This diffraction grating 61 also has a total of four different regions 60a to 60d, just as did the diffraction grating 60 in FIG. 3.

Next, the beam split by the diffraction grating 61 will be described. 70a is the +1^{st}-order diffracted light, and 70e the −1^{st}-order diffracted light, reflected by the information recording plane 40b and diffracted in the region 61a of the diffraction grating 61, 70b is the +1^{st}-order diffracted light, and 70f the −1^{st} -order diffracted light, diffracted in the region 61b, 70c is the +1^{st}-order diffracted light, and 70g the −1^{st}-order diffracted light, diffracted in the region 61c, and 70d is the +1^{st}-order diffracted light, and 70h the −1^{st}-order diffracted light, diffracted in the region 61d. The beams 70a to 70h are incident on the photodetector 34 as shown in FIG. 9. The TE signal here is obtained by (I34e+I34j)−(I34f+I34i)−K·((I34h+I34k)−(I34g+I34l)). In this case, the signal for the groove component of the optical recording medium is obtained as a larger signal than the TE error signal of Embodiment 1, so tracking can be controlled even more stably. Therefore, with the optical information device in this embodiment, fluctuation in the TE signal amplitude is reduced and tracking can be carried out more stably, so information can be recorded or reproduced at high reliability.

Also, with the photodetector 34 of this embodiment, even if the number of information recording planes is increased, the same disposition of the photodetection components as in Embodiment 1 can be performed, allowing tracking error to be controlled stably. Embodiment 4

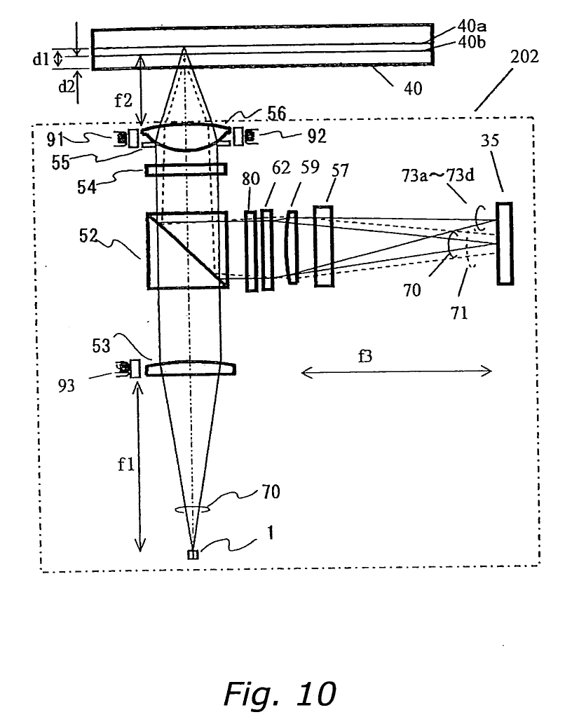

FIG. 10 is a diagram of an example of the structure of another optical pickup device 202 pertaining to this embodiment.

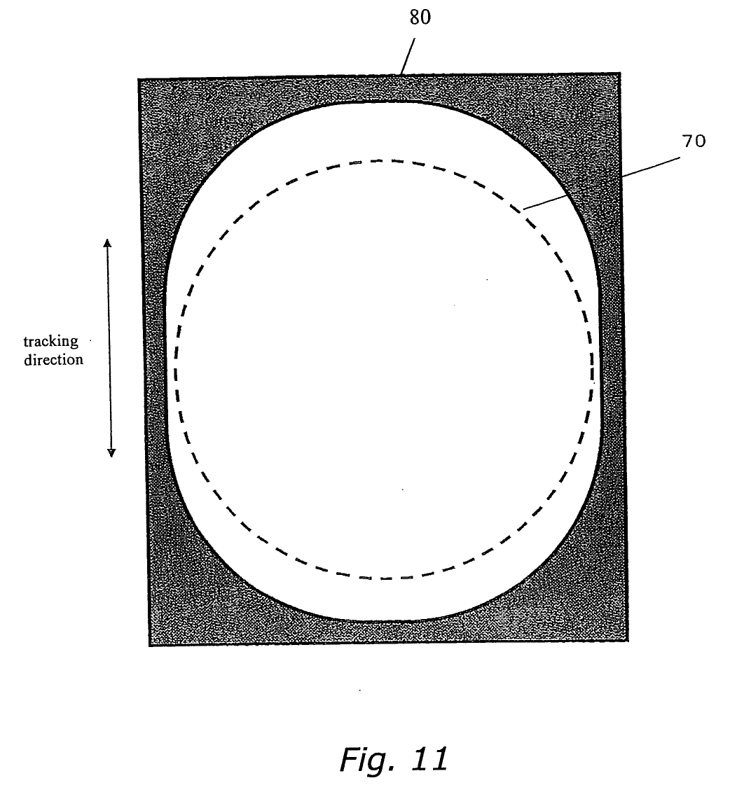

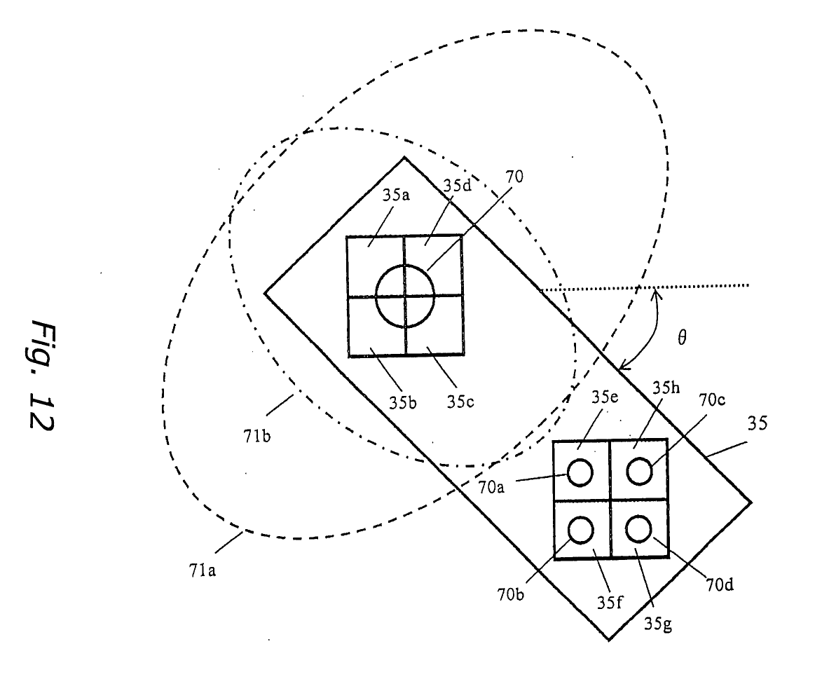

The difference from Embodiment 1 is that a diffraction grating 62 is used instead of the diffraction grating 60 (the beam splitting unit), and an opening limiting element 80 (opening limiting unit) and a photodetector 35 (instead of the photodetector 32) are provided in the vicinity of the diffraction grating 62. The opening limiting element 80 has the structure shown in FIG. 11. Specifically, it has an oval shape that is longer in the direction corresponding to the tracking direction of the objective lens 56, and the center of this oval shape and the center of the diffraction grating 62 kept in a substantially coinciding positional relationship. The beam that passes through the region on the outside of this oval shape is blocked and prevented from going into the photodetector 35. The difference between the diffraction grating 62 and the diffraction grating 60 of Embodiment 1 is that the direction of diffraction is obtained by Θ rotation of the zero-order diffracted light around the center (see FIG. 12). Θ here is approximately 40 to 50 degrees, and preferably 45 degrees. Also, in Embodiments 1 to 3, the shape in which the beam reflected by the information recording plane 40b (on which the beam was not focused) was incident on the photodetector 35 in the optical recording medium 40 was expressed schematically as being circular. However, in actual practice, since the beam reflected from the information recording plane passes through the cylindrical lens 57, the reflected beam from an unfocused information recording plane has an elliptical shape on the photodetector 35. Also, the orientation of the ellipse of the beam reflected by an unfocused information recording plane on the photodetector 35 is determined by the direction of the curved plane of the cylindrical lens 57.

Also, as shown in FIG. 12, the light receivers 35e to 35h that receive the beams 70a to 70d split by the diffraction grating 62 are disposed in a different direction from the diffraction direction on the track on the information recording plane 40a of the zero-order diffracted light that has passed through the diffraction grating 62. In this embodiment, these light receivers are disposed in a direction rotated by approximately 40 to 50 degrees with respect to the track diffraction direction, and are in a positional relationship in which they receive the beams 70a to 70d split by the diffraction grating 62. The TE signal in this optical pickup is obtained by (I35e−I35f)−K·(I35h−I35g), just as in Embodiment 1.

With an optical pickup structured as above, when the focal point of the objective lens 56 is on the information recording plane 40b, the map of the beam 71 a reflected by the information recording plane 40aon the photodetector 35 is the elliptical shape indicated by the dotted line in FIG. 12, and when the focal point of the objective lens 56 is on the information recording plane 40a, the map of the beam 71b reflected by the information recording plane 40b on the photodetector 35 is an elliptical shape rotated by 90 degrees from 71a, and the blocking effect of the opening limiting element 80 produces the map indicated by the dotted line shown in FIG. 12.

When the opening limiting element 80, the diffraction grating 62, and the photodetector 35 are combined as above, there is no stray light on the light receivers 35e to 35h of the photodetector 35, which detect the TE signal, so stable tracking control is possible. Therefore, with the optical information device of this embodiment, fluctuation in the TE signal amplitude is reduced and tracking can be carried out more stably, so information can be recorded or reproduced at high reliability.

Furthermore, with this embodiment, the opening limiting element 80 was formed separately from the diffraction grating 62, but the same effect can be obtained by forming it integrally with the diffraction grating. Also, the opening may be limited by giving the diffraction grating 62 a holder shape.

### Other Embodiments

Embodiments 1 to 4 described above are just examples, and various modifications are possible without exceeding the gist of the present invention. The following are examples thereof

In the above embodiments, the diffraction gratings 60 to 62 were split into four regions, but the number of regions into which they are split is not limited to this. Specifically, the constitution may be such that the diffraction grating is divided into a region mainly including the tracking groove component of the information recording plane, and a region including substantially no tracking groove component.

Also, there is no need to use all of the regions within a beam to produce the TE signal, and a situation in which, for example, no TE signal is used near the center of the beam can also be applied to the present invention, and the same effect as above can be obtained.

The use of a polarizing optical system was described above, but a non-polarizing optical system may be used instead.

No FE signal detection systems other than an astigmatism process were described because this is not related to the gist of the present invention, but there is no restriction whatsoever on how the FE signal is detected, and a spot size detection method, a Foucault method, or any other ordinary FE signal detection method can be used.

Even when there is variance in the track position, width, or depth during the production of the optical recording medium, or when an optical recording medium is used whose TE signal amplitude fluctuates when information is recorded to a track, all the optical information devices given in these embodiments will still reduce fluctuation in the TE signal amplitude and allow stable tracking. Therefore, the yield of the optical recording medium is increased, and a less expensive optical recording medium can be provided.

Also, because an optical recording medium whose TE signal amplitude fluctuates is permissible, a laser beam can be used to cut out the masters of optical recording medium at higher speed, so this is faster than using an electron beam to cut out masters, and masters can be produced less expensively. This allows the optical recording medium to be provided at a cost that is correspondingly lower.

With the above-mentioned embodiments, the wavelength of the light source 1 was 405 nm and the numerical aperture NA of the objective lens 56 was set at 0.85, but the advantages of the optical. information device pertaining to these embodiments will be particularly pronounced when tp/0.8<λ/NA <0.5 μm.

### INDUSTRLAL APPLICABILITY

The optical information device pertaining to the present invention can be used in applications such as optical information device that require a reduction in the fluctuation of the TE signal amplitude and the ability to record or reproduce information at high reliability.

1-20. (canceled)

21. An optical information device, comprising:
a light source for emitting a light beam;
a focusing unit for converging the light beam emitted from the light source onto a predetermined information recording plane of an optical recording medium having a plurality of information recording planes;
a beam splitting unit for splitting the light beam reflected by the optical recording medium; and
a light detection unit having a light receiver that receives the light beam split by the beam splitting unit, for outputting a signal corresponding to the light intensity of the light beams received by the light receiver,
wherein a guide groove is formed on at least one of the information recording planes, and the light receiver is entirely disposed within a map formed on the light detection unit by the light beam reflected by an information recording plane other than the predetermined information recording plane (hereinafter referred to as non-convergence plane).

22. The optical information device according to claim 21, further comprising:
an astigmatism generation unit disposed along the optical path between the focusing unit and the light receiver.

23. The optical information device according to claim 22, wherein the astigmatism generation unit is a cylindrical lens.

24. The optical information device according to claim 21,
wherein the light detection unit has a plurality of the light receivers, and each of the light. receivers is disposed so as to receive the light beam reflected by the same non-convergence plane.

25. The optical information device according to claim 24,
wherein at least a portion of the plurality of light receivers are disposed roughly adjacent to each other, and
the light beams split by the beam splitting unit are each received by at least the portion of the light receivers.

26. The optical information device according to claim 21,
wherein the beam splitting unit has at least first to fourth regions, and
the light beam split in the first to forth regions is incident on the light receiver that outputs a signal for producing a tracking error signal.

27. The optical information device according to claim 26,
wherein the light beams split in the first and second regions mainly include 1^{st} order diffracted light diffracted by the track of the optical recording medium,
the light beams split in the third and fourth regions mainly include zero-order diffracted light diffracted by the track of the optical recording medium,
the light detection unit has first to fourth light receivers that receive the light beams split in the first to fourth regions, respectively, and
the tracking error signal is expressed by (I1−12)−K·(I4−I3), where I1 to I4 are signals outputted from the first to fourth light receivers, and K is a real number.

28. The optical information device according to claim 21,
wherein the beam splitting unit has at least first to fourth regions,
the light beams split in the first and second regions mainly include 1^{st} order diffracted light diffracted by the track of the optical recording medium,
the light beams split in the third and fourth regions mainly include zero-order diffracted light diffracted by the track of the optical recording medium,
the light detection unit has first to fourth light receivers that receive the light beams split in the first to fourth regions, respectively, and a fifth light receiver disposed at a location where the light beams split by the beam splitting unit are not received, and
the tracking error signal is expressed by ((I1−I2)−K·(I4−I3))−L·15, where I1 to I5 are signals outputted from the first to fifth light receivers, and K and L are real numbers, then .

29. The optical information device according to claim 21,
wherein the beam splitting unit is a diffraction grating, and
a tracking error signal is produced by using the +1^{st} order diffracted light or −1^{st} order diffracted light diffracted by the diffraction grating.

30. The optical information device according to claim 29,
wherein the light receivers for receiving the +1^{st} order diffracted light and −1^{st} order diffracted light diffracted by the diffraction grating are disposed substantially in axially symmetric locations on either side of the optical axis of the zero-order diffracted light of the diffraction grating, and
a tracking error signal is produced using both +1^{st} order diffracted light and −1^{st} order diffracted light.

31. An optical information device, comprising:
a light source for emitting a light beam;
a focusing unit for converging the light beam emitted from the light source onto a predetermined information recording plane of an optical recording medium having a plurality of information recording planes;
a beam splitting unit for splitting the light beam reflected by the optical recording medium;
an opening limiting unit disposed in the vicinity of the beam splitting unit; and
a light detection unit having a light receiver that receives the light beam split by the beam splitting unit, for outputting a signal corresponding to the light intensity of the light beams received by the light receiver,
wherein a guide groove is formed on at least one of the information recording planes,
the light detection unit has at least a first light receiver for focus control and a second light receiver for tracking control; and
the second light receiver is disposed outside a map formed on the light detection unit by the light beam reflected by an information recording plane other than the predetermined information recording plane (hereinafter referred to as non-convergence plane) and limited by the opening limiting unit.

32. The optical information device according to claim 31, further comprising:
an astigmatism generation unit disposed along the optical path between the focusing unit and the light receivers.

33. The optical information device according to claim 32,
wherein the astigmatism generation unit is a cylindrical lens.

34. The optical information device according to claim 31,
wherein the second light receiver is disposed, with respect to the first light receiver, in a disposition direction other than the direction in which the light beam is diffracted by the track of the optical recording medium.

35. The optical information device according to claim 34,
wherein the disposition direction is a direction rotated by approximately 40 to 50 degrees from the direction in which the light beam is diffracted by the track of the optical recording medium.

36. The optical information device according to claim 31,
wherein the second light receiver has a plurality of light receiving regions disposed roughly adjacent to each other, and
the light beams split by the beam splitting unit are received in these light receiving regions.

37. The optical information device according to claim 31,
wherein the beam splitting unit has at least four regions, and
the light beams split in the regions are incident on the second light receiver that outputs a signal for producing a tracking error signal.

38. The optical information device according to claim 31,
wherein the beam splitting unit is a diffraction grating.

39. The optical information device according to claim 31,
wherein the opening limiting unit is formed integrally with the beam splitting unit.

40. An information recording and reproduction device, comprising:
the optical information device according to claim 21;
a transfer controller for moving the optical information device;
a controller for controlling the optical information device and the transfer controller;
a recording and reproduction unit for recording and/or reproducing information to or from an optical recording medium using the optical information device; and
a rotating unit for rotationally moving the optical information device.

41. An information recording and reproduction device, comprising:
the optical information device according to claim 31;
a transfer controller for moving the optical information device;
a controller for controlling the optical information device and the transfer controller;
a recording and reproduction unit for recording and/or reproducing information to or from an optical recording medium using the optical information device; and
a rotating unit for rotationally moving the optical information device.
